(19) United States
(12) Patent Application Publication
(10) Pub. No.: US 2007/0191527 A1
(43) Pub. Date: Aug. 16, 2007

(54) POLYMER EXFOLIATED PHYLLOSILICATE NANOCOMPOSITE COMPOSITIONS AND A PROCESS FOR THE PREPARATION THEREOF

(75) Inventors: Shroff Rama Mallikarjuna, Pune (Maharashtra) (IN); Swaminathan Sivaram, Pune (Maharashtra) (IN)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: COUNCIL OF SCIENTIFIC AND INDUSTRIAL RESEARCH, New Delhi (IN)

(21) Appl. No.: 11/625,149

(22) Filed: Jan. 19, 2007

(30) Foreign Application Priority Data
Feb. 13, 2006 (IN) 0401/DEL/2006

(51) Int. Cl. C08K 9/04

(52) U.S. Cl. 524/445

(57) ABSTRACT

The present invention provides a polymer-phyllosilicate nanocomposite composition comprising (a) 10-99.95% by weight of a matrix polymer and (b) 0.05-90% by weight of a phyllosilicate selected from the group consisting of hydrophilic synthetic phyllosilicates and natural phyllosilicates intercalated with a modifier, an alkylonium ion having reactive moiety. The phyllosilicate is substantially homogeneously dispersed and/or exfoliated throughout the polymer matrix as nanosized particles and the alkylonium ion is substantially covalently linked to the matrix polymer chains. The present invention further provides a process for the preparation of polymer-phyllosilicate nanocomposite.

### RELATED APPLICATIONS

This application claims priority to Indian Patent Application No. 0401/DEL/2006, dated Feb. 13, 2006, the teachings of which are incorporated herein by reference.

### FIELD OF THE INVENTION

The present invention relates to polymer exfoliated phyllosilicate nanocomposites compositions and process for preparation thereof. More particularly it relates to polymer-exfoliated phyllosilicate nanocomposite compositions, comprising: (a) a matrix polymer; (b) a phyllosilicate selected from the group consisting of hydrophilic synthetic phyllosilicates and natural phyllosilicates, wherein the phyllosilicate has a surface; and (c) a modifier, an alkylonium ion with reactive moiety associated with the surface of the phyllosilicate and capable of compatiblize or covalently link to the matrix polymer chains. The phyllosilicate is substantially homogeneously dispersed and/or exfoliated throughout the polymer matrix as nanosized particles and the alkylonium ion is substantially covalently linked to the matrix polymer chains.

### BACKGROUND OF THE INVENTION

Nanocomposites are defined as the particle filled composites of which the particle should have at least one dimension in the nanometer range. Phyllosilicates when dispersed in the polymer matrix will have a plate like structure in which the thickness of the plate is one nanometer. These nanocomposites are ideally classified into conventional composites, intercalated nanocomposites, intercalated-flocculated nanocomposites and exfoliated nanocomposites.

It is known that organophilic phyllosilicates prepared, for example, by ion exchange, can be used as fillers for thermoplastic materials and also for thermosets, giving nanocomposites. When suitable organophilic phyllosilicates are used as fillers, the physical and mechanical properties of the moldings thus produced are considerably improved. A particular interesting feature is the increase in stiffness with no decrease in toughness. Nanocomposites, which comprise the phyllosilicate in exfoliated form, have particularly good properties.

Nanocomposites have been demonstrated to produce dramatic improvements in mechanical properties, heat resistance, thermal stability, and reduced gas permeability of the base polymer without loss of impact strength. Due to their enhanced barrier properties and clarity, nanocomposites are well suited for use as gas transport barriers in packaging applications. Examples include nylon-based nanocomposites for food and beverage packaging, which incorporate the nanocomposite layer within single or multi-layer films. Reduction in gas diffusion is attributed to the presence of the clay particles, which act to increase diffusion path length.

U.S. Pat. No. 4,810,734 has disclosed that phyllosilicates can be treated with a quaternary or other ammonium salt of a primary, secondary or tertiary linear organic amine in the presence of a dispersing medium. During this there is ion exchange or cation exchange, where the cation of the ammonium salt becomes embedded into the space between the layers of the phyllosilicate. The organic radical of the absorbed amine makes phyllosilicates modified in this way organophilic. When this organic radical comprises functional groups the organophilic phyllosilicate is able to enter into chemical bonding with a suitable monomer or polymer.

There are many examples in the patent literature of polymer/clay nanocomposites prepared from monomers and treated clays. For example, U.S. Pat. No. 4,739,007 discloses the preparation of Nylon-6/clay nanocomposites from caprolactam and alkyl ammonium-treated montmorillonite.

However the above-mentioned phyllosilicates which are modified with alkylammonium cations undergo degradation at the temperatures above 250° C. as illustrated in the published literature, Xie et. al., Chemistry of Materials, 2001 13, 2979-2990, the disclosures of which are incorporated by reference herein. The decomposition of these modifiers during the preparation of nanocomposites or during processing leads to degradation of the polymers by chain scission reactions, color formation etc. The formation of decomposition products can lead to emissions and to impairment of mechanical properties, for example impact strength. For the preparation of polymer/clay nanocomposites wherein the polymer resins such as polycarbonates, polyethylene terepthalate, or any other polymer whose processing temperatures are above the 250° C., requires treatment with modifiers, which are thermally stable. The use of thermally stable modifiers based on cyclic amidinium ions is disclosed in the U.S. Pat. Nos. 5,530,052, 5,707,439, 6,197,849, 20040033392A1, the disclosure of which are incorporated by reference herein. The use of thermally stable modifiers based on phosphonium ions is disclosed in U.S. Pat. Nos. 6,057,035, 6,287,992, 6,262,162, 6,359,052, the disclosure of which are incorporated by reference herein. However the dispersion of layered phyllosilicates, which are modified with such amidinium or phosphonium based surfactants, in the polymer resin was poor and always resulted in intercalated nanocomposites wherein the clay platelets are still remain intact and polymer chains have intercalated in between the clay gallery and increase the interlayer distance. Polycarbonate nanocomposites, as disclosed in U.S. patent No. 2004/0030021 A1, have resulted in only intercalated nanocomposites and sometimes decrease in interlayer distance for the phyllosilicate due to deintercalation of the modifier itself. It is shown that maximum improvement in the properties can be exploited only when the platelets are completely delaminated/exfoliated in the polymer resin matrix. It is also shown that when the modifier is capable of anchoring the polymer chains will enhance interaction of the polymer resin with the phyllosilicate layered platelets and under suitable process in making the nanocomposite result in fully exfoliated nanocomposites.

### OBJECTIVES OF THE INVENTION

The main object of the present invention is to provide nanocomposite compositions in which the intercalated layered material (organophyllosilicate) is completely dispersed or exfoliated into the matrix polymer.

Another object of the present invention is to provide nanocomposite compositions wherein the intercalated layered material comprises of alkylonium ions having reactive moiety.

Yet another object of the present invention is to provide intercalated layered materials wherein the alkylonium ion having reactive moiety is stable at temperatures of preparation and processing of the nanocomposite compositions.

Yet another object of the present invention is to provide nanocomposite compositions wherein the alkylonium ions having reactive moiety associated with the layered material is substantially covalently linked to or compatabilizing the matrix polymer chain.

Still another object of the present invention is to provide processes for production of the intercalated layered material (organophyllosilicate).

Still another object of the present invention is to provide processes for dispersing the intercalated layered material in the matrix polymer to produce nanocomposite compositions.

### SUMMARY OF THE INVENTION

An embodiment of the present invention provides a polymer-phyllosilicate nanocomposite composition comprising
(a) 10-99.95% by weight of a matrix polymer and
(b) 0.05-90% by weight of a phyllosilicate selected from the group consisting of hydrophilic synthetic phyllosilicates and natural phyllosilicates intercalated with a modifier, an alkylonium ion having reactive moiety.

The present invention further provides a process for the preparation of polymer-phyllosilicate nanocomposite composition comprising
(a) 10-99.95% by weight of a matrix polymer and
(b) 0.05-90% by weight of a phyllosilicate selected from the group consisting of hydrophilic synthetic phyllosilicates and natural phyllosilicates intercalated with a modifier, an alkylonium ion having reactive moiety,
   the said process comprises intercalating a layered silicate material by contacting it with alkylonium ions having reactive group to obtain the intercalated layered material, mixing the above said intercalated layered material with a melt of the matrix polymer, under stirring, to intercalate and exfoliate the said matrix polymer between adjacent platelets of the layered silicate material to obtain the desired polymer-exfoliated phyllosilicate nanocomposite composition.

In yet another embodiment a process for the preparation of polymer-phyllosilicate nanocomposite comprising 40% to 99.95% by weight of a matrix polymer and about 0.05% to about 60% by weight of an intercalate and/or exfoliate, the said process comprising intercalating and/or exfoliating a layered silicate material by contacting the layered silicate material with alkylonium ions having reactive moiety to exchange the alkylonium ions having reactive moiety for at least a portion of the interlayer exchangeable cations of the layered material, mixing the above said intercalated layered silicate material with one or more monomer or oligomer reactants and subjecting it to conditions sufficient to polymerize the said monomer or oligomer reactants to form said matrix polymer.

In yet another embodiment of a process for the preparation of polymer-phyllosilicate nanocomposite comprising contacting a layered silicate material with alkylonium ions having reactive moiety to intercalate the alkylonium ions having reactive moiety between the adjacent layers of said layered silicate material, thereby increasing the spacing between adjacent layers of the layered material to at least 3 Å, simultaneously or subsequently contacting the above said intercalated layered silicate material with a solution or dispersion of an oligomer or polymer to intercalate the oligomer or polymer between the adjacent layers of the said layered silicate material to expand the spacing between the adjacent layers to at least an additional 3 Å and mixing the layered silicate material, having said alkylonium ions having reactive moiety and said oligomer or polymer intercalated between adjacent layers and/or exfoliated, with an oligomer or polymer matrix material.

### DETAILED DESCRIPTION OF THE INVENTION

The present invention provides a polymer-phyllosilicate nanocomposite composition comprising (a) 10-99.95% by weight of a matrix polymer and (b) 0.05-90% by weight of a phyllosilicate selected from the group consisting of hydrophilic synthetic phyllosilicates and natural phyllosilicates intercalated with a modifier, an alkylonium ion having reactive moiety. Particularly useful alkylonium ions are those capable of compatiblize or covalently link to the matrix polymer chains. In a preferred embodiment of the present invention, the phyllosilicate is substantially homogeneously dispersed and/or exfoliated throughout the polymer matrix as nanosized particles and the alkylonium ion is substantially covalently linked to the matrix polymer chains.

In an embodiment of the present invention the matrix polymer used is selected from the group consisting of polycarbonates, polyesters and epoxy resins.

In yet another embodiment the matrix polymer used is a polycarbonate.

In yet another embodiment the modifier used is alkylonium ion having reactive moiety.

In yet another embodiment the alkylonium ion used is associated with the surface of the phyllosilicate and capable of covalently link to the matrix polymer chain.

In yet another embodiment the phyllosilicate used is homogeneously dispersed and/or exfoliated throughout the polymer matrix as nanosized particles.

In yet another embodiment the phyllosilicate used is selected from the group consisting of natural smectite clays, synthetic smectite clays, kaolinite clays, mica, natural talcs, synthetic talcs, and combinations thereof.

In yet another embodiment the smectite clay used is selected from the group comprising of montmorillonite, hectorite, saponite, beidellite, stevensite, nontronite, laponite, and combinations thereof.

In yet another embodiment the alkyl chain of alkylonium ion used has at least one carbon atom.

In yet another embodiment the alkyl chain of alkylonium ion used is selected from the chain length of 2 to 37 carbon atoms.

In yet another embodiment the alkyl chain of alkylonium ion used is selected from the chain length of 3 to 18 carbon atoms.

In yet another embodiment the alkyl chain of alkylonium ion used is selected from the chain length of 8 to 12 carbon atoms.

In yet another embodiment the onium ion used in alkylonium ion is selected from the group consisting of phosphonium ions, cyclic amidinium ions and ammonium ions.

In yet another embodiment the reactive moiety of alkylonium ion comprises at least one phenol group.

In yet another embodiment the reactive moiety of alkylonium ion used is a bisphenol group

In yet another embodiment the alkylonium ion used is 2,2-bis(4-hydroxyphenyl) alkylonium salts having the formula I,

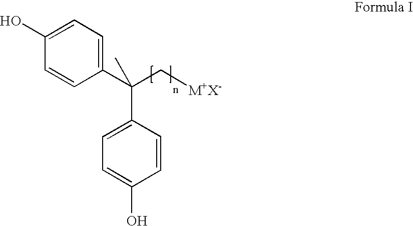

where n=1 to 37, M=trialkylphosphonium, triarylphosphonium, triarylalkylphosphonium, ammonium or substituted cylic amidinium radical selected from the group consisting of pyrrole, imidazole, thiazole, oxazole, pyridine, pyrimidine, quinoline, isoquinoline, indole, purine, benzimidazole, benzothiazole, benzoxazole, pyrazine, quinoxaline, quinozoline, acridine, phenazine, imidazopyridine, and dipyridyl, X═Cl, Br, I, BF₄, OTf, or NTf₂.

In yet another embodiment the alkylonium ion used is 2,2-bis(4-hydroxyphenyl)alkylonium salts, wherein n=11.

In yet another embodiment the alkylonium ion used is 2,2-bis(4-hydroxyphenyl)alkylonium salts, wherein M is triphenylphosphine.

In yet another embodiment the alkylonium ion used is 2,2-bis(4-hydroxyphenyl)alkylonium salts, wherein M is 1,2-dimethylimidazole.

The present invention further provides a nanocomposite composition comprising about 0.05 weight percent to about 40 weight percent of a phyllosilicate material intercalated with the alkylonium ion having reactive moiety (organophyllosilicate) and about 60 weight percent to about 99.95 weight percent of a matrix polymer, characterized in that the said intercalated layered silicate material is dispersed uniformly throughout the matrix polymer and/or exfoliated wherein the said alkyl onium ions are compatible with the matrix polymer or substantially covalently linked to the matrix polymer chain through the reactive moiety.

In yet another embodiment the matrix polymer is co-intercalated into the phyllosilicate material or the silicate layers are exfoliated.

In yet another embodiment the matrix polymer is co-intercalated into the layered silicate material while dispersing or exfoliating the layered material throughout the matrix polymer.

In yet another embodiment the matrix polymer is co-intercalated into the layered silicate material prior to dispersing or exfoliating the layered silicate material throughout the matrix polymer.

In yet another embodiment the matrix polymer used is a polymer or oligomer of the reaction product of bisphenols and diphenylcarbonate.

In yet another embodiment the nanocomposite composition comprising about 40% to about 99.95% by weight of a matrix polymer and about 0.05% to about 60% by weight of an intercalated organophyllosilicate material prepared by contacting a phyllosilicate with intercalant alkylonium ions having reactive moiety capable of compatibilize or covalently link the matrix polymer chain with a molar ratio of alkylonium ions having reactive moiety to phyllosilicate interlayer exchangeable cations of at least about 0.25:1 to achieve sorption of the alkylonium ions between adjacent spaced layers of the phyllosilicate to expand the spacing between a predominance of the adjacent phyllosilicate platelets at least about 3 Å, when measured after sorption of the alkylonium ions, and a second intercalant disposed between adjacent spaced layers of the phyllosilicate material, said second intercalant comprising a thermosetting or thermoplastic oligomer or polymer.

In yet another embodiment the intercalated phyllosilicate is exfoliated into a predominance of individual platelets.

In yet another embodiment the molar ratio of intercalant alkylonium ions having reactive moiety to phyllosilicate interlayer exchangeable cations used is at least 0.5:1.

In yet another embodiment the molar ratio of intercalant alkylonium ions having reactive moiety:phyllosilicate interlayer exchangeable cations is at least 1:1.

In yet another embodiment the matrix polymer used is selected from the group consisting of epoxy, polyamide, polyvinyl alcohol, polycarbonate, polyvinylimine, polyvinylpyrrolidone, polyethylene terephthalate and polybutylene terephthalate.

In yet another embodiment the matrix polymer used is a polycarbonate.

The present invention further provides a nanocomposite composition comprising about 10% about 90% by weight of a layered material intercalated with alkylonium ions having reactive group and about 10% to about 90 weight percent of a matrix oligomer or polymer, wherein the intercalated or the exfoliated layered silicate material is dispersed uniformly throughout the matrix polymer.

In yet another embodiment the matrix polymer used is intercalated into the layered silicate material.

In yet another embodiment the matrix polymer used is intercalated into the layered silicate material while dispersing or exfoliating the layered material throughout the matrix polymer.

In yet another embodiment the matrix polymer used is intercalated into the layered silicate material prior to dispersing or exfoliating the layered silicate material throughout the matrix polymer.

In yet another embodiment both the matrix polymer and the polymer intercalated into and/or exfoliate the layered material are a polymer or oligomer of the reaction product of bisphenols and diphenylcarbonate.

In yet another embodiment the layered silicate material used is first intercalated with alkylonium ions having reactive moiety prior to intercalating the layered material with the polymer of bisphenol and diphenylcarbonate.

The present invention also provides processes for producing polymer-phyllosilicate nanocomposite compositions. In an embodiment of a process according to the invention, the process includes contacting, and thereby intercalating, a layered silicate material, e.g., a phyllosilicate, with an alkylonium ion having at least one reactive moiety and co-intercalation of the layered material with a co-intercalant (as co-intercalant polymerizable reactants, or as the oligomer co-intercalant or polymer co-intercalant) to form nanocomposite materials in which, the co-intercalant monomer, oligomer or polymer can be intercalated after or together with intercalation of the alkylonium ion having reactive moiety such as by direct compounding, e.g., by combining a alkylonium ion having reactive moiety-intercalated layered material and a co-intercalant monomer, polymer or oligomer in a mixing or extruding device to produce the co-intercalated layered material and the nanocomposite or by combining a alkylonium ion having reactive moiety-intercalated layered material and a co-intercalant monomer, or oligomer reactants capable of polymerizing to form said matrix polymer, while in contact with said intercalate, and subjecting the mixture to conditions sufficient to polymerize said reactants to form said matrix polymer in the nanocomposite.

In another embodiment, the present invention further provides a process for the preparation of polymer-phyllosilicate nanocomposite composition comprising
(a) 10-99.95% by weight of a matrix polymer and
(b) 0.05-90% by weight of a phyllosilicate selected from the group consisting of hydrophilic synthetic phyllosilicates and natural phyllosilicates intercalated with a modifier, an alkylonium ion having reactive moiety,
   the said process comprises intercalating a layered silicate material by contacting it with alkylonium ions having reactive group to obtain the intercalated layered material, mixing the above said intercalated layered material with a melt of the matrix polymer, under stirring, to intercalate and exfoliate the said matrix polymer between adjacent platelets of the layered silicate material to obtain the desired polymer-exfoliated phyllosilicate nanocomposite composition.

In yet another embodiment mixing of intercalate and the polymer melt is accomplished by extruding the intercalate/polymer melt mixture.

In yet another embodiment of a process for the preparation of polymer-phyllosilicate nanocomposite comprising 40% to 99.95% by weight of a matrix polymer and about 0.05% to about 60% by weight of an intercalate and/or exfoliate, the said process comprises intercalating and/or exfoliating a layered silicate material by contacting the layered silicate material with alkylonium ions having reactive moiety to exchange the alkylonium ions having reactive moiety for at least a portion of the interlayer exchangeable cations of the layered material, mixing the above said intercalated layered silicate material with one or more monomer or oligomer reactants and subjecting it to conditions sufficient to polymerize the said monomer or oligomer reactants to form said matrix polymer.

In yet another embodiment of a process for the preparation of polymer-phyllosilicate nanocomposite comprises contacting a layered silicate material with alkylonium ions having reactive moiety to intercalate the alkylonium ions having reactive moiety between the adjacent layers of said layered silicate material, thereby increasing the spacing between adjacent layers of the layered material to at least 3 Å, simultaneously or subsequently contacting the above said intercalated layered silicate material with a solution or dispersion of an oligomer or polymer to intercalate the oligomer or polymer between the adjacent layers of the said layered silicate material to expand the spacing between the adjacent layers to at least an additional 3 Å and mixing the layered silicate material, having said alkylonium ions having reactive moiety and said oligomer or polymer intercalated between adjacent layers and/or exfoliated, with an oligomer or polymer matrix material.

In yet another embodiment the oligomer or polymer intercalated between adjacent layers of said layered silicate material or exfoliated is the same oligomer or polymer matrix material mixed with said intercalate.

In yet another embodiment the alkylonium ions intercalated phyllosilicate is obtained by exchanging the exchangeable cations in the phyllosilicate with 2,2-bis(4-hydroxyphenyl)alkylonium salt having formula 1,

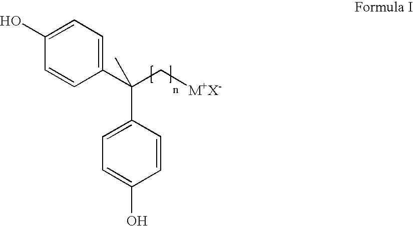

wherein n=1 to 37, M=trialkylphosphonium, triarylphosphonium, triarylalkylphosphonium, ammonium or substituted cylic amidinium radical selected from the group consisting of pyrrole, imidazole, thiazole, oxazole, pyridine, pyrimidine, quinoline, isoquinoline, indole, purine, benzimidazole, benzothiazole, benzoxazole, pyrazine, quinoxaline, quinozoline, acridine, phenazine, imidazopyridine and dipyridyl; X═Cl, Br, I, BF₄, OTf, or NTf₂.

In yet another embodiment the exchanging is done by first dispersing the phyllosilicate in a polar solvent and then adding the alkylonium salt and stirring it together at a temperatures in the range of 10° C. to 100° C. for a period of 0.5 h to 24 h and then filtering the organophyllosilicate cake, followed by washing it with a solvent to remove excess salt and the metallic salt which has come out of the adjacent sheets of the phyllosilicate, and drying it under vacuum in a freeze drier to obtain the desired fine particles of organophyllosilicate.

In accordance of the present invention the matrix polymers in the practice of this invention may vary widely from thermoplastics to thermosetting polymers. Illustrative of useful thermoplastic resins, which may be used alone or in admixture, are polyactones such as poly(pivalolactone), poly(caprolactone) and the like; polyurethanes derived from reaction of diisocyanates such as 1,5-naphthalene diisocyanate; p-phenylene diisocyanate, m-phenylene diisocyanate, 2,4-toluene diisocyanate, 4,4′-diphenylmethane diisocyanate, 3,3′-dimethyl-4,4′-biphenyl diisocyanate, 4,4′-diphenylisopropylidene diisocyanate, 3,3′-dimethyl-4,4′-diphenyl diisocyanate, 3,3′-dimethyl-4,4′-diphenylmethane diisocyanate, 3,3′-dimethoxy-4,4′-biphenyl diisocyanate, dianisidine diisocyanate, toluidine diisocyanate, hexamethylene diisocyanate, 4,4′-diisocyanatodiphenylmethane and the like and linear long-chain diols such as poly(tetramethylene adipate), poly(ethylene adipate), poly(1,4-butylene adipate), poly(ethylene succinate), poly(2,3-butylene succinate), polyether diols and the like; polycarbonates such as poly[methane bis(4-phenyl)carbonate], poly[1,1-ether bis(4-phenyl)carbonate], poly[diphenylmethane bis(4-phenyl)carbonate], poly[1,1-cyclohexane bis(4-phenyl)carbonate] and the like; polysulfones; polyethers; polyketones; polyamides such as poly(4-amino butyric acid), poly(hexamethylene adipamide), poly(6-aminohexanoic acid), poly(m-xylylene adipamide), poly(p-xylylene sebacamide), poly(2,2,2-trimethyl hexamethylene terephthalamide), poly(metaphenylene isophthalamide), poly(p-phenylene terephthalamide), and the like; polyesters such as poly(ethylene azelate), poly(ethylene-1,5-naphthalate, poly(1,4-cyclohexane dimethylene terephthalate), poly(ethylene oxybenzoate), poly(para-hydroxy benzoate), poly(1,4-cyclohexylidene dimethylene terephthalate) (cis), poly(1,4-cyclohexylidene dimethylene terephthalate) (trans), polyethylene terephthalate, polybutylene terephthalate and the like; poly(arylene oxides) such as poly(2,6-dimethyl-1,4-phenylene oxide), poly(2,6-diphenyl-1,4-phenylene oxide) and the like; poly(arylene sulfides) such as poly(phenylene sulfide) and the like; polyetherimides; vinyl polymers and their copolymers such as polyvinyl acetate, polyvinyl alcohol, polyvinyl chloride; polyvinyl butyral, polyvinylidene chloride, ethylene-vinyl acetate copolymers, and the like; polyacrylics, polyacrylate and their copolymers; ionomers; poly(epichlorohydrins); poly(urethane) such as the polymerization product of diols such as glycerin, trimethylol-propane, 1,2,6-hexanetriol, sorbitol, pentaerythritol, polyether polyols, polyester polyols and the like with a polyisocyanate such as 2,4tolylene diisocyanate, 2,6-tolylene diisocyante, 4,4′-diphenylmethane diisocyanate, 1,6-hexamethylene diisocyanate, 4,4′-dicyclohexyl-methane diisocyanate and the like; and polysulfones such as the reaction product of the sodium salt of 2,2-bis(4-hydroxyphenyl)propane and 4,4′-dichlorodiphenyl sulfone; furan resins such as poly(furan); and blends of two or more of the foregoing.

The present invention provides a polymer-phyllosilicate nanocomposite composition comprising (a) 10-99.95% by weight of a matrix polymer and (b) 0.05-90% by weight of a phyllosilicate selected from the group consisting of hydrophilic synthetic phyllosilicates and natural phyllosilicates intercalated with a modifier, an alkylonium ion having reactive moiety, the polyamides for use as a matrix polymer are those formed by polymerization of amino acids and derivatives thereof, as, for example, lactams. Illustrative of these useful polyamides are poly(4-aminobutyric acid) (nylon 4), poly(6-aminohexanoic acid) (nylon 6), poly(7-aminoheptanoic acid) (nylon 7), poly(8-aminooctanoic acid) (nylon 8), poly(9-10-aminononanoic acid) (nylon 9), poly(10-aminodecanoic acid) (nylon 10), poly(11-aminoundecanoic acid) (nylon 11), poly(12-aminododecanoic acid) (nylon 12) and the like. Other useful polyamides, generally known in the art as nylons, obtained from condensation of diamines and dibasic acids having the recurring unit represented by the general formula:

—NHCOR¹COHNR²—

in which R¹ is an alkylene group of at least 2 carbon atoms, preferably from about 2 to about 18; or arylene having at least about 6 carbon atoms, preferably about 6 to about 17 carbon atoms; and R² is selected from R¹ and aryl groups.

In yet another embodiment of the present invention, the polyester chosen for use as a matrix polymer can be a homo-polyester or a copolyester, or mixtures thereof, as desired. Polyesters are normally prepared by the condensation of an organic dicarboxylic acid and an organic diol, and, the reactants can be added to the intercalates, or exfoliated intercalates for in situ polymerization of the polyester while in contact with the layered material, before or after exfoliation of the intercalates. Polyesters which are suitable for use as matrix polymers in this embodiment of the invention are those which are derived from the condensation of aromatic, cycloaliphatic, and aliphatic diols with aliphatic, aromatic and cycloaliphatic dicarboxylic acids and may be cycloaliphatic, aliphatic or aromatic polyesters.

The present invention provides a polymer-phyllosilicate nanocomposite composition comprising (a) 10-99.95% by weight of a matrix polymer and (b) 0.05-90% by weight of a phyllosilicate selected from the group consisting of hydrophilic synthetic phyllosilicates and natural phyllosilicates intercalated with a modifier, an alkylonium ion having reactive moiety, the most preferred thermoplastic polymers for use as matrix polymer such as polycarbonates, more particularly the polycarbonates derived from the condensation of bisphenol-A and diphenyl carbonate.

In accordance of the present invention, the other polycarbonates useful as matrix polymer include homopolymers, copolymers or blends of the polymers derived from the condensation of diphenols and corbonate precursors. The copolycarbonates may also contain units corresponding to the dihydroxy compounds disclosed by name or formula (generic or specific) in U.S. Pat. No. 4,217,438, the disclosure of which is incorporated by reference herein. Other useful polycarbonates comprises the units which include those having the formula II

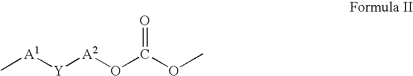

wherein each of A¹ and A² is a monocyclic divalent aromatic radical and Y is a bridging radical in which one or two atoms separate A¹ from A². The free valence bonds in formula m are usually in the meta or para positions of A¹ and A² in relation to Y. The A¹ and A² values may be unsubstituted phenylene or substituted derivatives thereof, illustrative substituents (one or more) being alkyl, alkenyl, halo (especially chloro and/or bromo), nitro, alkoxy and the like. Unsubstituted phenylene radicals are preferred. Both A¹ and A² are preferably p-phenylene, although both may be o- or m-phenylene or one o- or m-phenylene and the other p-phenylene. The bridging radical, Y, is one in which one or two atoms, preferably one, separate A¹ from A². It is most often a hydrocarbon radical and particularly a saturated radical such as methylene, cyclohexylmethylene, 2-[2.2.1]-bicyclohep-tylmethylene, ethylene, isopropylidene, neopentylidene, cyclohexylidene, cyclopentadecylidene, cyclododecylidene or adamantylidene, especially a gem-alkylene (alkylidene) radical. Also included, however, are unsaturated radicals and radicals which contain atoms other than carbon and hydrogen; for example, 2,2-dichloroethylidene, carbonyl, phthalidyhdene, oxy, thio, sulfoxy and sulfone. For reasons of availability and particular suitability for the purposes of this invention, the preferred units of formula 11 are 2,2-bis(4-phenylene)propane carbonate units, which are derived from bisphenol A and in which Y is isopropylidene and A¹ and A² are each p-phenylene.

In accordance of the present invention, the phyllosilcate may be from the group of useful swellable materials include but not limited to phyllosilicates, such as smectite clay minerals, e.g., montmorillonite, particularly sodium montmorillonite; magnesium montmorillonite and/or calcium montmorillonite; nontronite; beidellite; volkonskoite; hectorite; saponite; sauconite; sobockite; stevensite; svinfordite; vermiculite; and the like. Other useful layered materials include micaceous minerals, such as illite and mixed layered illite/smectite minerals, such as rectorite, tarosovite, ledikite and admixtures of illites with the clay minerals named above.

In accordance of the present invention, the swellable layered materials are phyllosilicates of the 2:1 type having a negative charge on the layers ranging from about 0.15 to about 0.9 charges per formula unit and a commensurate number of exchangeable metal cations in the interlayer spaces. Most preferred layered materials are smectite clay minerals such as montmorillonite, nontronite, beidellite, volkonskoite, hectorite, saponite, sauconite, sobockite, stevensite, svinfordite and combinations thereof.

In accordance of the present invention, the modifier is an alkylonium ion having at least one reactive moiety such as phenol group. Useful alkylonium ion having reactive moiety can be selected from the novel class of 2,2-bis(4-hydroxyphenyl)alkylonium salts having the formula 1, where n=1 to 37, M=trialkylphosphonium or triarylphosphonium or triarylalkylphosphonium or substituted cyclic amidinium radical which include pyrrole, imidazole, thiazole, oxazole, pyridine, pyrimidine, quinoline, isoquinoline, indole, purine, benzimidazole, benzothiazole, benzoxazole, pyrazine, quinoxaline, quinozoline, acridine, phenazine, imidazopyridine, or dipyridyl or ammonium X═Cl, Br, I, BF₄, OTf, NTf₂, etc.,

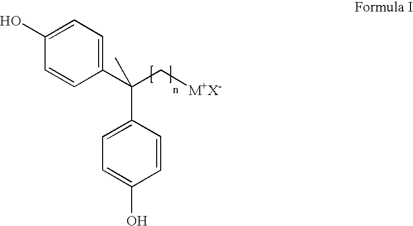

In an embodiment of the present invention, the modifier is chosen such that they are stable after intercalating and sorbed into the layered material at temperatures of production and processing of the nanocomposite.

In an embodiment of the present invention, the process for the preparation of polymer-exfoliated phyllosilicate nanocomposite compositions involves preparation by contacting, and thereby intercalating, a layered silicate material, e.g., a phyllosilicate, such as a smectite clay, with an alkylonium ion having at least one reactive moiety and co-intercalation of the layered material with a co-intercalant (as co-intercalant polymerizable reactants, or as the oligomer co-intercalant or polymer co-intercalant) to form nanocomposite materials. The co-intercalant monomer, oligomer or polymer can be intercalated after or together with intercalation of the alkylonium ion having reactive moiety such as by direct compounding, e.g., by combining a alkylonium ion having reactive moiety-intercalated layered material and a co-intercalant monomer, polymer or oligomer in a mixing or extruding device to produce the co-intercalated layered material and the nanocomposite. The interlaminar spacing of adjacent layers (platelets) of the layered material (d-spacing minus one platelet thickness of the layered material) is expanded by at least 3 Å, preferably by at least 10 Å, more preferably by at least 15 Å, even more preferably by at least 18 Å, even more preferably by at least 20 Å, and more preferably by at least 25 Å by contacting the layered material with the alkylonium ion having reactive moiety for simultaneous or subsequent intercalation with co-intercalant polymerizable reactants, an oligomer co-intercalant or a polymer co-intercalant. The alkylonium ion having reactive moiety have at least one phenol group, preferably a bisphenol group and ion-exchange atoms capable of ion-exchanging with Li⁺, Na⁺, K⁺, Ca⁺², Mg⁺², or other inorganic cations that occur within the interlayer spaces between adjacent silicate layers or platelets of the layered silicate materials being intercalated. The exchange of layered material inorganic cations with alkylonium ions having reactive groups not only enables the conversion of the hydrophilic interior clay platelet surfaces to organophilic platelet surfaces but also can form covalent link by reacting and/or compatibilize with the co-intercalant monomer, oligomer or polymer, which forms the matrix polymer.

In accordance of the present invention, a fully polymerized co-intercalant polymer, having a weight average molecular weight between about 100 and about 5 million, preferably about 1,000 to about 500,000, can be co-intercalated between adjacent platelets of the alkylonium ion having reactive moiety-intercalated layered material, preferably simultaneously with dispersing or exfoliating the multi-charged onium ion-intercalated layered material into a matrix polymer. The matrix polymer or the oligomer or the monomers can be compounded with the layered material simultaneously or subsequently after the intercalation of the alkylonium ion having the reactive moiety into the layered material to exfoliate up to 100% of the tactoids into individual platelets such that more than 50% by weight of the patelets are in the form of single platelets, e.g., more than 60%; more than 70%; more than 80%; or more than 90% by weight of the layered material can be completely exfoliated.

In accordance with the preferred embodiment of the present invention, the monomers, which can be polymerized to form the matrix polymer under suitable conditions is mixed with organophyllosilicate, which is obtained by modifying with alkylonium ion having reactive moiety and stable at temperatures of polymerization and then polymerized in-situ to form the nanocomposite compositions.

In accordance of the present invention, exfoliates can be prepared from intercalate or intercalate concentrate composition by diluting it in a (or additional) matrix polymer wherein intercalate or the intercalate concentrate compositions are obtained by direct compounding of the intercalated layered material with a matrix polymer melt, one or more matrix polymers or mixing the intercalated layered material with the monomers and polymerized in-situ under suitable conditions to get the matrix polymer.

In accordance of the present invention, to form the nanocomposite compositions, the layered material, e.g., the phyllosilicate, which is swelled or intercalated by sorption of an alkylonium ion having reactive moiety to form intercalated layered material (organophyllosilicates) is simultaneously or subsequently co-intercalated with a co-intercalant polymerizable monomer, oligomer or polymer.

In accordance of the present invention alkylonium ion having reactive moiety can be selected from the novel class of 2,2-bis(4-hydroxyphenyl)alkylonium salts having the formula 1, where n=1 to 37, M=trialkylphosphonium or triarylphosphonium or triarylalkylphosphonium or substituted cylic amidinium radical which include pyrrole, imidazole, thiazole, oxazole, pyridine, pyrimidine, quinoline, isoquinoline, indole, purine, benzimidazole, benzothiazole, benzoxazole, pyrazine, quinoxaline, quinozoline, acridine, phenazine, imidazopyridine, or dipyridyl or ammonium X═Cl, Br, I, BF₄, OTf, NTf₂, etc.,

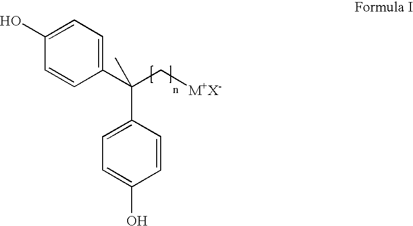

In accordance of the present invention, any swellable layered material that sufficiently sorbs the alkylonium ion having reactive moiety to increase the interlayer spacing between the adjacent phyllosilicate platelets by at least 3 Å, preferably by at least 10 Å, more preferably by at least 15 Å, even more preferably by at least 18 Å, even more preferably by at least 20 Å, and more preferably by at least 25 Å can be used in practice of this invention. Useful swellable materials include but not limited to phyllosilicates, such as smectite clay minerals, e.g., montmorillonite, particularly sodium montmorillonite; magnesium montmorillonite and/or calcium montmorillonite; nontronite; beidellite; volkonskoite; hectorite; saponite; sauconite; sobockite; stevensite; svinfordite; vermiculite; and the like. Other useful layered materials include micaceous minerals, such as illite and mixed layered illite/smectite minerals, such as rectorite, tarosovite, ledikite and admixtures of illites with the clay minerals named above.

In accordance of the present invention, the preferred swellable layered materials are phyllosilicates of the 2:1 type having a negative charge on the layers ranging from about 0.15 to about 0.9 charges per formula unit and a commensurate number of exchangeable metal cations in the interlayer spaces. Most preferred layered materials are smectite clay minerals such as montmorillonite, nontronite, beidellite, volkonskoite, hectorite, saponite, sauconite, sobockite, stevensite, and svinfordite.

In accordance of the present invention, the amount of alkylonium ion having reactive moiety intercalated in to the swellable layered materials, in order that the intercalated layered material platelet surfaces sufficiently ion exchange with the alkylonium ions having reactive moiety such that the adjacent platelets of the layered material may be sufficiently spaced for easy co-intercalation of a polymeric or polymerizable co-intercalant, may be of the molar ratio of alkylonium ions having reactive moiety:phyllosilicate interlayer exchangeable cations of at least about 0.25:1, preferably at least 0.50:1, more preferably of at least 1:1.

In accordance of the present invention, the alkylonium ion having reactive moiety may be introduced into (sorbed within) the interlayer spaces of the layered material in a number of ways. In a preferred method of intercalating the alkylonium ion having reacting group between the layered material, the layered material is slurried in water, e.g., at 5-20% by weight layered material and 80-95% by weight water, and the alkylonium ion having the reactive moiety, dissolved in water or any other alcoholic solvent, is added to the slurried layered material and stirred for 0.5 to 24 h at temperatures chosen in the range of 20 to 100° C. The layered material then filtered and can be washed with suitable solvent to remove the excess alkylonium ion having the reactive moiety and the displaced metal ions. It is then dried thoroughly prior to the incorporation of the co-intercalating polymer or polymerizable oligomer or monomers. The resulting alkylonium ion having reactive moiety intercalated layered material is sufficiently organophilic and are capable of covalently linking the matrix polymer chains during in-situ polymerization while dispersing the layered material in the polymer matrix.

In accordance with the preferred embodiment of the present invention, the alkylonium ion having reactive moiety intercalated layered material is co-intercalated with any polymer or any polymerizable oligomer or monomers and then polymerized in-situ, to get the nanocomposite compositions or the concentrates. Later the concentrates can be diluted by dispersing it in to one or more melt processible thermoplastic and/or thermosetting matrix oligomers or polymers, or mixtures thereof, by direct compounding. Most preferably the matrix polymer is co-intercalated into the alkyloniumion having reactive moiety intercalated layered material, further increasing the interlayer distance by at least 3 Å, preferably by at least 10 Å, more preferably by at least 15 Å, even more preferably by at least 18 Å, even more preferably by at least 20 Å, and more preferably by at least 25 Å, even more preferably the layers are well separated and exfoliated in the matrix polymer. The co-intercalation of the matrix polymer is done either by direct compounding of the polymer with the intercalated material under melt or by mixing the polymerizable oligomers or the monomers under melt or in solution followed by subjecting it to polymerization conditions to form the matrix polymer. In the most preferred embodiment of the present invention the co-intercalation is done by mixing the polymerizable monomers or the oligomers under melt or in solution followed by polymerization at suitable conditions under melt or in solid state, and under these conditions the reactive moiety in the alkylonium ion of the modifier present in the layered material may react with the matrix polymer chains and form covalent link and disperse or exfoliate the layered material in the polymer matrix.

The following examples are given by way of illustration and therefore should not be construed to limit the scope of the present invention.

### EXAMPLE 1

Equivalent amounts of 2,2-bis-(4-hydroxyphenyl)tridecyl bromide (4.4746 g, 0.010 mol) and 1,2-dimethylimidazole (0.9613 g, 0.010 mol) were mixed and heated at 100° C. for 8 hours under nitrogen atmosphere. The melted mixture solidified after the reaction. 2,2-bis-(4-hydroxyphenyl)tridecyl-(1,2-dimethylimidazolium)bromide was obtained in pure form and used without further purification.

### EXAMPLE 2

Equivalent amounts of 2,2-bis-(4-hydroxyphenyl)tridecyl bromide (4.4746 g, 0.010 mol) and triphenylphosphine (2.631 g, 0.010 mol) were mixed and heated at 100° C. for 8 hours under nitrogen atmosphere. The melted mixture solidified after the reaction. 2,2-bis-(4-hydroxyphenyl)tridecyl triphenylphosphonium bromide was obtained in pure form and used without further purification.

### EXAMPLE 3-7

The Na montmorinollite (10 g) with CEC 92 meq/100 g, d spacing 12 Å was dispersed in water/methanol (300 mL) by stirring with an over head stirrer at room temperature for 2 hours. The modifier (11 meq), as shown in table 1, dissolved in methanol/water mixture was poured into the dispersion of clay slowly in drops and stirred for 24 hours at 65° C. The reaction mixture is cooled, centrifuged and washed several times with distilled water and methanol until all the bromide ions are washed off. The organoclay obtained was freeze dried under vacuum overnight. The organoclay was obtained as fine, dry powder. The interlayer d-spacing for the organo modified montmorillonite was measured from wide angle X-ray diffraction (WAXD) and is shown in table 1. The onset of decomposition and organic contents were measured from the thermogravimetric analysis upon charring the organoclay at 900° C. and are shown in table 1.

TABLE 1

| | | d-spacing | | Onset of |
|---|---|---|---|---|
| | | for | Organic | decom- |
| | | organoclay | content | position |
| E.g. | Modifier | (Å) | (wt %) | ° C. |
| 3 | 12,12-bis-(4-hydroxyphenyl) | 28.7 | 40 | 250 |
| | triphenyl phosphonium | | | |
| | bromide | | | |
| 4 | 12,12-bis-(4-hydroxyphenyl)- | 23.0 | 32 | 250 |
| | 1,2-dimethylimidazolium) | | | |
| | bromide | | | |
| 5 | Hexadecyltriphenyl | 21.5 | 33 | 300 |
| | phosphonium bromide | | | |
| 6 | Hexadecyl-1,2-dimethyl | 18.5 | 26 | 315 |
| | imidazolium bromide | | | |
| 7 | Dihydrogenated tallow | 24.8 | 38 | 200 |
| | dimethylammonium bromide | | | |

### EXAMPLE 8

Polycarbonate clay nanocomposite was prepared via in-situ polymerization by mixing diphenyl carbonate (9.110 g), bisphenol-A (8.908 g) and organoclay of example 3 (0.500 g) along with NaOH/tetramethylammonium hydroxide as the catalyst using a overhead stirrer heated to melt at 180° C. under nitrogen atmosphere for 15 minutes. Then the temperature was raised to 290° C. in stages of 210° C., 240° C., 260° C. and then to 290° C., while reducing the pressure in stages of 180 mbar, 100 mbar, 20 mbar, 3.5 mbar and finally to <0.010 mbar over a period of 165 minutes. Then it is kept at 290° C. for a period of 120 minutes under the vacuum of <0.010 mbar to get the nanocomposite. The nanocomposite obtained was characterized by transmission electron microscope (TEM) and WAXD and they showed that the layered silicates are completely dispersed and exfoliated in the matrix polycarbonate with no peaks for the clay in the WAXD. The molecular weights of the polymer in the nanocomposite were determined by gel permeation chromatography (GPC) and were found to be number average molecular weight (Mn) of 16500 and dispersity of 2.2.

### EXAMPLE 9

Polycarbonate clay nanocomposite was prepared via in-situ polymerization by mixing diphenyl carbonate (9.110 g), bisphenol-A (8.908 g, mol) and organoclay of example 4 (0.500 g) along with NaOH/tetramethylammonium hydroxide as the catalyst using a overhead stirrer heated to melt at 180° C. under nitrogen atmosphere for 15 minutes. Then the temperature was raised to 290° C. in stages of 210° C., 240° C., 260° C. and then to 290° C., while reducing the pressure in stages of 180 mbar, 100 mbar, 20 mbar, 3.5 mbar and finally to <0.010 mbar over a period of 165 minutes. Then it is kept at 290° C. for a period of 120 minutes under the vacuum of <0.010 mbar to get the nanocomposite. The nanocomposite obtained was characterized by TEM and WAXD and they showed that the layered silicates are completely dispersed and exfoliated in the matrix polycarbonate with no peaks for the clay in the WAXD. The molecular weights of the polymer in the nanocomposite were determined by GPC and were found to be Mn of 14500 and dispersity of 2.4.

### COMPARATIVE EXAMPLE 1

Polycarbonate clay nanocomposite was prepared via in-situ polymerization by mixing diphenyl carbonate (9.111 g), bisphenol-A (8.980 g) and organoclay of example 5 (0.500 g) along with NaOH/tetramethylammonium hydroxide as the catalyst using a overhead stirrer heated to melt at 180° C. under nitrogen atmosphere for 15 minutes. Then the temperature was raised to 290° C. in stages of 210° C., 240° C., 260° C. and then to 290° C., while reducing the pressure in stages of 180 mbar, 100 mbar, 20 mbar, 3.5 mbar and finally to <0.010 mbar over a period of 165 minutes. Then it is kept at 290° C. for a period of 120 minutes under the vacuum of <0.010 mbar to get the nanocomposite. The nanocomposite obtained was characterized by WAXD and TEM and they showed that the layered silicates are flocculated in the matrix polycarbonate with the interlayer d-spacing of 17.8 Å. The molecular weights of the polymer in the nanocomposite were determined by GPC and were found to be Mn of 9500 and dispersity of 2.1.

### COMPARATIVE EXAMPLE 2

Polycarbonate clay nanocomposite was prepared via in-situ polymerization by mixing diphenyl carbonate (9.111 g), bisphenol-A (8.980 g) and organoclay of example 6 (0.500 g) along with NaOH/tetramethylammonium hydroxide as the catalyst using a overhead stirrer heated to melt at 180° C. under nitrogen atmosphere for 15 minutes. Then the temperature was raised to 290° C. in stages of 210° C., 240° C., 260° C. and then to 290° C., while reducing the pressure in stages of 180 mbar, 100 mbar, 20 mbar, 3.5 mbar and finally to <0.010 mbar over a period of 165 minutes. Then it is kept at 290° C. for a period of 120 minutes under the vacuum of <0.010 mbar to get the nanocomposite. The nanocomposite obtained was characterized by WAXD and TEM and they showed that the layered silicates are dispersed in the matrix polycarbonate with the interlayer d-spacing of 27.6 Å. The molecular weights of the polymer in the nanocomposite was determined by GPC and was found to be Mn of 9800 and dispersity of 2.2.

### COMPARATIVE EXAMPLE 3

Polycarbonate clay nanocomposite was prepared via in-situ polymerization by mixing diphenyl carbonate (9.111 g), bisphenol-A (8.980 g) and organoclay of example 7 (0.500 g) along with NaOH/tetramethylammonium hydroxide as the catalyst using a overhead stirrer heated to melt at 180° C. under nitrogen atmosphere for 15 minutes. Then the temperature was raised to 290° C. in stages of 210° C., 240° C., 260° C. and then to 290° C. o while reducing the pressure in stages of 180 mbar, 100 mbar, 20 mbar, 3.5 mbar and finally to <0.010 mbar over a period of 165 minutes. Then it is kept at 290° C. for a period of 120 minutes under the vacuum of <0.010 mbar to get the nanocomposite. The nanocomposite obtained was characterized by WAXD and TEM and they showed that the layered silicates are dispersed in the matrix polycarbonate with the interlayer d-spacing of 29.9 Å. The molecular weights of the polymer in the nanocomposite were determined by GPC and were found to be Mn of 7800 and dispersity of 2.6. The molecular weight of the polymer in this nanocomposite is very low and the material also is found to be dark colored as compared to the products obtained from example 8, example 9, comparative example 1 and comparative example 2.

### The Main Advantages of the Present Invention are

1. Provides the nanocomposite compositions in which the layered material is completely dispersed and exfoliated in the polymer matrix while the alkylonium ion having the reactive moiety is covalently linked to the matrix polymer chain.

2. Provide processes for the production of the nanocomposite compositions.

We claim:

1. A polymer-phyllosilicate nanocomposite composition comprising
(a) 10-99.95% by weight of a matrix polymer and
(b) 0.05-90% by weight of a phyllosilicate selected from the group consisting of hydrophilic synthetic phyllosilicates and natural phyllosilicates intercalated with a modifier, an alkylonium ion having reactive moiety.

2. The composition as claimed in claim 1, wherein the matrix polymer is selected from the group consisting of polycarbonates, polyesters and epoxy resins.

3. The composition as claimed in claim 1, wherein the matrix polymer is a polycarbonate.

4. The composition as claimed in claim 1 wherein the modifier is alkylonium ion having reactive moiety.

5. The composition as claimed in claim 1 wherein the alkylonium ion is associated with the surface of the phyllosilicate and capable of covalently link to the matrix polymer chain.

6. The composition as claimed in claim 1 wherein the phyllosilicate is homogeneously dispersed and/or exfoliated throughout the polymer matrix as nanosized particles.

7. The composition as claimed in claim 1, wherein the phyllosilicate is selected from the group consisting of natural smectite clays, synthetic smectite clays, kaolinite clays, mica, natural talcs, synthetic talcs, and combinations thereof.

8. The composition as claimed in claim 7, wherein the smectite clay is selected from the group comprising of montmorillonite, hectorite, saponite, beidellite, stevensite, nontronite, laponite, and combinations thereof.

9. The composition as claimed in claim 4, wherein the alkyl chain of alkylonium ion has at least one carbon atom.

10. The composition as claimed in claim 4, wherein the alkyl chain of alkylonium ion is having the chain length of 2 to 37 carbon atoms.

11. The composition as claimed in claim 10, wherein the alkyl chain of alkylonium ion is having chain length of 3 to 18 carbon atoms.

12. The composition as claimed in claim 11, wherein the alkyl chain of alkylonium ion is having chain length of 8 to 12 carbon atoms.

13. The composition as claimed in claim 1, wherein the alkylonium ion is selected from the group consisting of phosphonium ions, cyclic amidinium ions and ammonium ions.

14. The composition as claimed in claim 4, wherein the reactive moiety of alkylonium ion comprises at least one phenol group.

15. The composition as claimed in claim 4, wherein the reactive moiety of alkylonium ion is a bisphenol group.

16. The composition as claimed in claim 4, wherein the alkylonium ion is 2,2-bis(4-hydroxyphenyl)alkylonium salts having the formula I, 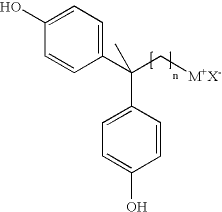
where n=1 to 37, M=trialkylphosphonium, triarylphosphonium, triarylalkylphosphonium, ammonium or substituted cylic amidinium radical selected from the group consisting of pyrrole, imidazole, thiazole, oxazole, pyridine, pyrimidine, quinoline, isoquinoline, indole, purine, benzimidazole, benzothiazole, benzoxazole, pyrazine, quinoxaline, quinozoline, acridine, phenazine, imidazopyridine, and dipyridyl, X═Cl, Br, I, BF₄, OTf, or NTf₂.

17. The composition as claimed in claim 16, wherein the alkylonium ion is 2,2-bis(4-hydroxyphenyl)alkylonium salts, wherein n=11.

18. The composition as claimed in claim 16, wherein the alkylonium ion is 2,2-bis(4-hydroxyphenyl)alkylonium salts, wherein M is triphenylphosphine.

19. The composition as claimed in claim 16, wherein the alkylonium ion is 2,2-bis(4-hydroxyphenyl)alkylonium salts, wherein M is 1,2-dimethylimidazole.

20. The composition as claimed in claim 1 comprising about 0.05 weight percent to about 40 weight percent of a phyllosilicate material intercalated with the alkylonium ion having reactive moiety (organophyllosilicate) and about 60 weight percent to about 99.95 weight percent of a matrix polymer, characterized in that the said intercalated layered silicate material is dispersed uniformly throughout the matrix polymer and/or exfoliated wherein the said alkyl onium ions are compatible with the matrix polymer or substantially covalently linked to the matrix polymer chain through the reactive moiety.

21. The composition as claimed in claim 20, wherein the matrix polymer is co-intercalated into the phyllosilicate material or the silicate layers are exfoliated.

22. The composition as claimed in claim 21, wherein the matrix polymer is co-intercalated into the layered silicate material while dispersing or exfoliating the layered material throughout the matrix polymer.

23. The composition as claimed in claim 22, wherein the matrix polymer is co-intercalated into the layered silicate material prior to dispersing or exfoliating the layered silicate material throughout the matrix polymer.

24. The composition as claimed in claim 20, wherein the matrix polymer used is a polymer or oligomer of the reaction product of bisphenols and diphenylcarbonate.

25. The composition as claimed in claim 1 comprising about 40% to about 99.95% by weight of a matrix polymer and about 0.05% to about 60% by weight of an intercalated organophyllosilicate material prepared by contacting a phyllosilicate with intercalant alkylonium ions having reactive moiety capable of compatibilize or covalently link the matrix polymer chain with a molar ratio of alkylonium ions having reactive moiety to phyllosilicate interlayer exchangeable cations of at least about 0.25:1 to achieve sorption of the alkylonium ions between adjacent spaced layers of the phyllosilicate to expand the spacing between a predominance of the adjacent phyllosilicate platelets at least about 3 Å, when measured after sorption of the alkylonium ions, and a second intercalant disposed between adjacent spaced layers of the phyllosilicate material, said second intercalant comprising a thermosetting or thermoplastic oligomer or polymer.

26. A composition as claimed in claim 25, wherein the intercalated phyllosilicate is exfoliated into a predominance of individual platelets.

27. A composition as claimed in claim 25, wherein the molar ratio of intercalant alkylonium ions having reactive moiety to phyllosilicate interlayer exchangeable cations is at least 0.5:1.

28. A composition as claimed in claim 25, wherein the molar ratio of intercalant alkylonium ions having reactive moiety:phyllosilicate interlayer exchangeable cations is at least 1:1.

29. A composition as claimed in claim 25, wherein the matrix polymer used is selected from the group consisting of epoxy, polyamide, polyvinyl alcohol, polycarbonate, polyvinylimine, polyvinylpyrrolidone, polyethylene terephthalate and polybutylene terephthalate.

30. A composition as claimed in claim 25, wherein the matrix polymer is a polycarbonate.

31. A composition as claimed in claim 1, comprising about 10% about 90% by weight of a layered material intercalated with alkylonium ions having reactive group and about 10% to about 90 by weight percent of a matrix oligomer or polymer, wherein the intercalated or the exfoliated layered silicate material is dispersed uniformly throughout the matrix polymer.

32. The composition as claimed in claim 31, wherein the matrix polymer is intercalated into the layered silicate material.

33. The composition as claimed in claim 32, wherein the matrix polymer is intercalated into the layered silicate material while dispersing or exfoliating the layered material throughout the matrix polymer.

34. The composition as claimed in claim 33, wherein the matrix polymer is intercalated into the layered silicate material prior to dispersing or exfoliating the layered silicate material throughout the matrix polymer.

35. The composition in accordance with claim 30, wherein both the matrix polymer and the polymer intercalated into and/or exfoliate the layered material are a polymer or oligomer of the reaction product of bisphenols and diphenylcarbonate.

36. The composition as claimed in claim 31, wherein the layered silicate material used is first intercalated with alkylonium ions having reactive moiety prior to intercalating the layered material with the polymer of bisphenol and diphenylcarbonate.

37. A process for the preparation of polymer-phyllosilicate nanocomposite composition comprising the steps of
(a) mixing 10-99.95% by weight of a matrix polymer and 0.05-90% by weight of a phyllosilicate selected from the group consisting of hydrophilic synthetic phyllosilicates and natural phyllosilicates intercalated with a modifier and an alkylonium ion having reactive moiety,
(b) intercalating a layered silicate material by contacting it with alkylonium ions having reactive group to obtain the intercalated layered material,
(c) mixing the above said intercalated layered material with a melt of the matrix polymer, under stirring, to intercalate and exfoliate the said matrix polymer between adjacent platelets of the layered silicate material to obtain the desired polymer-exfoliated phyllosilicate nanocomposite composition.

38. A process as claimed in claim 37, wherein mixing of intercalate and the polymer melt is accomplished by extruding the intercalate/polymer melt mixture.

39. A process for the preparation of polymer-phyllosilicate nanocomposite comprising the steps of
(a) mixing 40% to 99.95% by weight of a matrix polymer and about 0.05% to about 60% by weight of an intercalate and/or exfoliate,
(b) intercalating and/or exfoliating a layered silicate material by contacting the layered silicate material with alkylonium ions having reactive moiety to exchange the alkylonium ions having reactive moiety for at least a portion of the interlayer exchangeable cations of the layered material,
(c) mixing the above said intercalated layered silicate material with one or more monomer or oligomer reactants and subjecting it to conditions sufficient to polymerize the said monomer or oligomer reactants to form said matrix polymer.

40. A process for the preparation of polymer-phyllosilicate nanocomposite comprising the steps of
(a) contacting a layered silicate material with alkylonium ions having reactive moiety to intercalate the alkylonium ions having reactive moiety between the adjacent layers of said layered silicate material,
(b) increasing the spacing between adjacent layers of the layered material at least 3 Å, simultaneously or subsequently contacting the above said intercalated layered silicate material with a solution or dispersion of an oligomer or polymer to intercalate the oligomer or polymer between the adjacent layers of the said layered silicate material to expand the spacing between the adjacent layers at least an additional 3 Å, and
(c) mixing the layered silicate material, having said alkylonium ions having reactive moiety and said oligomer or polymer intercalated between adjacent layers and/or exfoliated, with an oligomer or polymer matrix material.

41. The process of claim 40, wherein the oligomer or polymer intercalated between adjacent layers of said layered silicate material or exfoliated is the same oligomer or polymer matrix material mixed with said intercalate.

42. A process as claimed in claim 40, wherein the alkylonium ions intercalated phyllosilicate is obtained by exchanging the exchangeable cations in the phyllosilicate with 2,2-bis(4-hydroxyphenyl)alkylonium salt having formula 1, 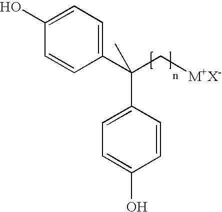
wherein n=1 to 37, M=trialkylphosphonium, triarylphosphonium, triarylalkylphosphonium, ammonium or substituted cylic amidinium radical selected from the group consisting of pyrrole, imidazole, thiazole, oxazole, pyridine, pyrimidine, quinoline, isoquinoline, indole, purine, benzimidazole, benzothiazole, benzoxazole, pyrazine, quinoxaline, quinozoline, acridine, phenazine, imidazopyridine and dipyridyl; X═Cl, Br, I, BF₄, OTf, or NTf₂.

43. A process as claimed in claim 42, wherein the exchanging is carried out by first dispersing the phyllosilicate in a polar solvent and then adding the alkylonium salt and stirring it together at a temperatures in the range of 10° C. to 100° C. for a period of 0.5 h to 24 h and then filtering the organophyllosilicate cake, followed by washing it with a solvent to remove excess salt and the metallic salt which has come out of the adjacent sheets of the phyllosilicate, and drying it under vacuum in a freeze drier to obtain the desired fine particles of organophyllosilicate.

44. A polymer-phyllosilicate nanocomposite composition and a process for the preparation thereof substantially as herein described with reference to the examples.
